(19) United States
(12) Patent Application Publication
(10) Pub. No.: US 2024/0298721 A1
(43) Pub. Date: Sep. 12, 2024

(54) WEARABLE APPARATUSES AND ASSOCIATED METHODS

(71) Applicant: The Boeing Company, Arlington, VA (US)

(72) Inventors: Michael F. Mitchell, Madison, AL (US); John D. Williams, Decatur, AL (US)

(73) Assignee: The Boeing Company, Arlington, VA (US)

(21) Appl. No.: 18/507,404

(22) Filed: Nov. 13, 2023

Related U.S. Application Data
(60) Provisional application No. 63/489,564, filed on Mar. 10, 2023.

(51) Int. Cl. A41D 1/00; G06F 3/16; H01M 10/42; H01M 50/105; H01M 50/178; H04R 1/02; H04R 5/027

(52) U.S. Cl. CPC A41D 1/005; G06F 3/162; H01M 10/425; H01M 50/105; H01M 50/178; H04R 1/028; H04R 5/027; H01M 2220/30

(57) ABSTRACT

A wearable apparatus includes a garment and a distributed electrical circuit. The garment includes a visible outer face directed away from a wearer and an inconspicuous inner face directed toward the wearer. The distributed electrical circuit inconspicuously integrated within the garment. The distributed electrical circuit includes a battery assembly, a microcontroller assembly, a memory assembly, a sensor assembly, a control assembly and a plurality of conductors arranged to interconnect the assemblies to form the circuit. A method of manufacturing the wearable apparatus is also provided.

### PRIORITY

This application claims priority from U.S. Ser. No. 63/489,564 filed on Mar. 10, 2023, the entire contents of which are incorporated herein by reference.

### FIELD

The present disclosure relates generally to wearable apparatuses and, particularly, to various examples of distributed electrical circuits inconspicuously integrated within the wearable apparatuses for measuring and/or recording certain environmental conditions relating to wearers of the wearable apparatuses. Various examples of methods of manufacturing the wearable apparatuses are also disclosed. For example, the wearable apparatuses can be used to monitor health and safety conditions as well as compliance with quality and certification standards. Other applications are also contemplated, such as collection of intelligence for law enforcement, security and defense.

### BACKGROUND

Growth in the wearable electronics industry is limited by the use of traditional rigid electronics which are cumbersome, heavy and create user frustration due to discomfort. Current wearables are focused on distributed sensing for temperature and motion with wireless connectivity to offload the data collected. These systems are either battery powered or use physical motion to operate battery-less.

Accordingly, those skilled in the art continue with research and development efforts to improve the design, integration and manufacturing of wearable electronics.

### SUMMARY

Disclosed are examples of wearable apparatuses and associated methods. The following is a non-exhaustive list of examples, which may or may not be claimed, of the subject matter according to the present disclosure.

In an example, the disclosed wearable apparatus includes a garment and a distributed electrical circuit. The garment is configured to be worn by a wearer. The garment includes a visible outer face directed away from the wearer and an inconspicuous inner face directed toward the wearer. The garment also includes at least one of (i) a collar, (ii) a lapel, (iii) a hood, (iv) at least one pocket, (v) at least one cuff, (vi) at least one placket, (vii) at least one pouch, (viii) at least one lining. (ix) at least one hem, (x) at least one seam and (xi) at least one double layered area. The distributed electrical circuit inconspicuously integrated within the garment. The distributed electrical circuit includes a battery assembly, at least one microcontroller assembly, at least one memory assembly, at least one sensor assembly, at least one control assembly and a plurality of conductors arranged to interconnect the battery assembly, the at least one microcontroller assembly, the at least one memory assembly, the at least one sensor assembly and the at least one control assembly to form the distributed electrical circuit. The battery assembly, the at least one microcontroller assembly, the at least one memory assembly, the at least one sensor assembly and the at least one control assembly are disposed in at least one of the collar, the lapel, the hood, the at least one pocket, the at least one cuff, the at least one placket, the at least one pouch, the at least one lining, the at least one hem, the at least one seam and the at least one double layered area.

In another example, the wearable apparatus includes a shirt configured to be worn by a wearer and a distributed electrical circuit inconspicuously integrated within the shirt. The shirt includes a visible outer face directed away from the wearer and an inconspicuous inner face directed toward the wearer. The shirt also includes a pointed collar, a patch pocket, sleeve cuffs, a button placket, a pouch, a bottom hem, top seams, side seams and armhole seams. The distributed electrical circuit includes a battery assembly, a microcontroller assembly, at least one memory assembly, an ambient sound sensor assembly, a location monitoring assembly, an ambient light and ambient air temperature assembly, a control assembly and a plurality of conductors arranged to interconnect the battery assembly, the microcontroller assembly, the at least one memory assembly, the ambient sound sensor assembly, the location monitoring assembly, the ambient light and ambient air temperature assembly and the control assembly to form the distributed electrical circuit.

In an example, the disclosed method of manufacturing a wearable apparatus includes: (1) obtaining fabric pieces used to form a garment configured to be worn by a wearer and including a visible outer face directed away from the wearer and an inconspicuous inner face directed toward the wearer; (2) obtaining a battery assembly, at least one microcontroller assembly, at least one memory assembly, at least one sensor assembly, at least one control assembly used in a distributed electrical circuit; and (3) selecting locations in the garment to inconspicuously integrate the battery assembly, the at least one microcontroller assembly, the at least one memory assembly, the at least one sensor assembly and the at least one control assembly from candidate locations including (i) a collar, (ii) a lapel, (iii) a hood, (iv) at least one pocket, (v) at least one cuff, (vi) at least one placket, (vii) at least one pouch, (viii) at least one lining, (ix) at least one hem, (x) at least one seam and (xi) at least one double layered area.

Other examples of the disclosed wearable apparatuses and associated methods will become apparent from the following detailed description, the accompanying drawings and the appended claims.

### BRIEF DESCRIPTION OF THE DRAWINGS

FIGS. 1A-D provide front views of several examples of wearable apparatuses;

FIG. 2 is a functional block diagram of an example of a distributed electrical circuit for integration within various examples of garments such as the garments in FIGS. 1A-D;

FIG. 3 is a functional block diagram of an example of a battery assembly of the distributed electrical circuit of FIG. 2;

FIG. 4 is a functional block diagram of an example of a microcontroller assembly of the distributed electrical circuit of FIG. 2;

FIG. 5 is a functional block diagram of an example of a memory assembly of the distributed electrical circuit of FIG. 2;

FIG. 6 is a functional block diagram showing several examples of sensor assemblies for the distributed electrical circuit of FIG. 2;

FIG. 7 is a functional block diagram of an example of an ambient sound sensor assembly for the distributed electrical circuit of FIG. 2;

FIG. 8 is a functional block diagram of an example of a location monitoring assembly for the distributed electrical circuit of FIG. 2;

FIG. 9 is a functional block diagram of another example of a location monitoring assembly for the distributed electrical circuit of FIG. 2;

FIG. 10 is a functional block diagram of an example of an ambient light and ambient air temperature assembly for the distributed electrical circuit of FIG. 2;

FIG. 11 is a functional block diagram of an example of a control assembly for the distributed electrical circuit of FIG. 2;

FIG. 12 provides a front view of another example of a wearable garment with an example of a distributed electrical circuit integrated therein;

FIG. 13 is a flow diagram of an example of a method of manufacturing a wearable garment with an example of a distributed electrical circuit integrated therein; and

FIG. 14, in combination with FIG. 13, is a flow diagram of another example of a method of manufacturing a wearable garment with an example of a distributed electrical circuit integrated therein.

### DETAILED DESCRIPTION

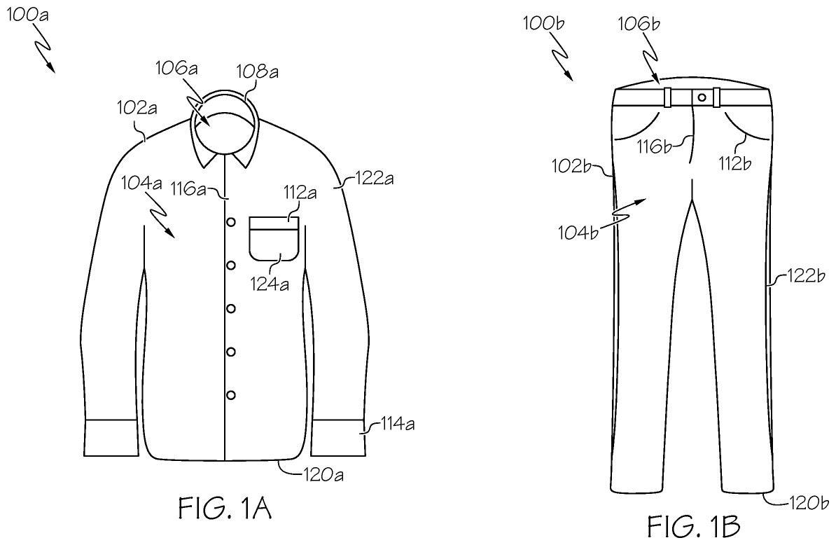

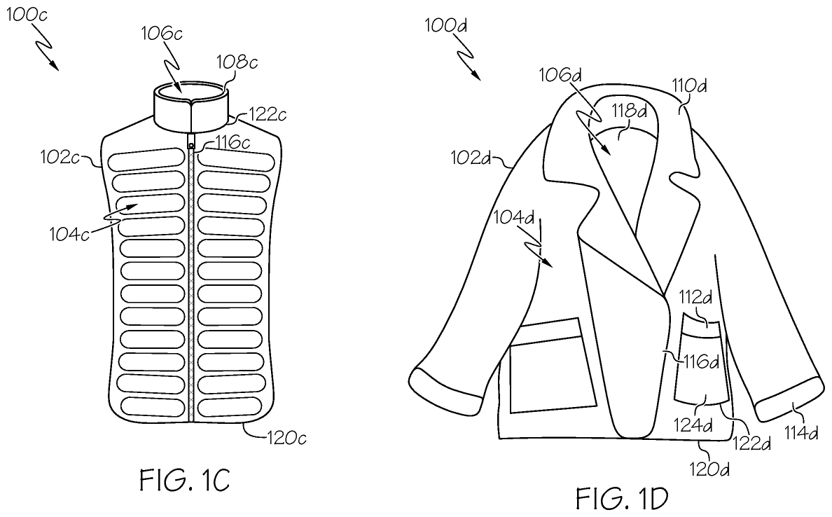

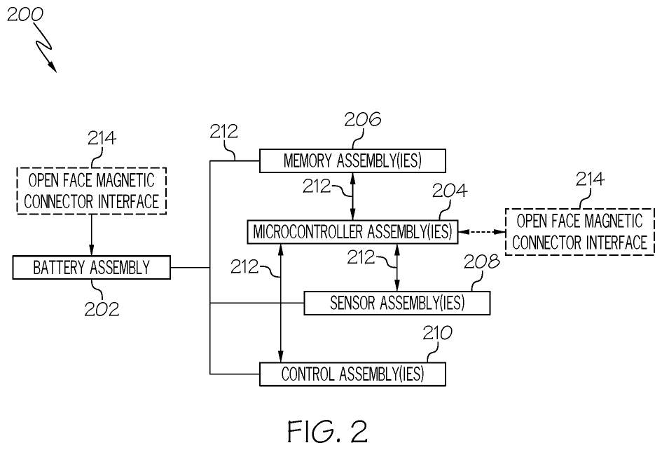

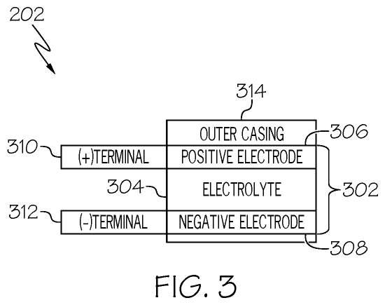

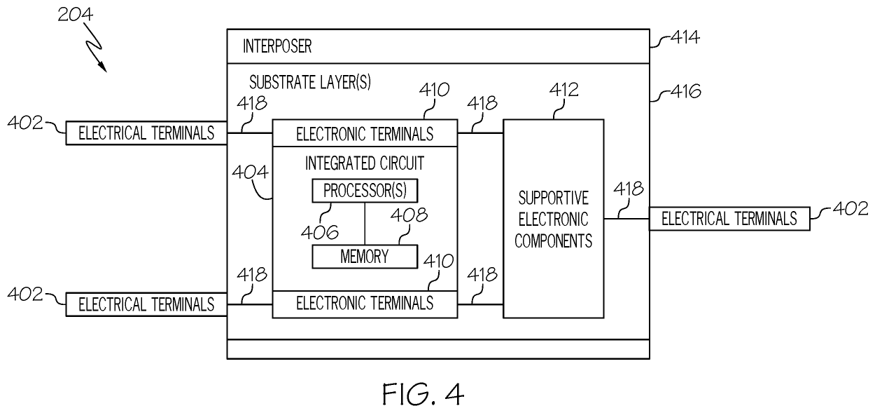

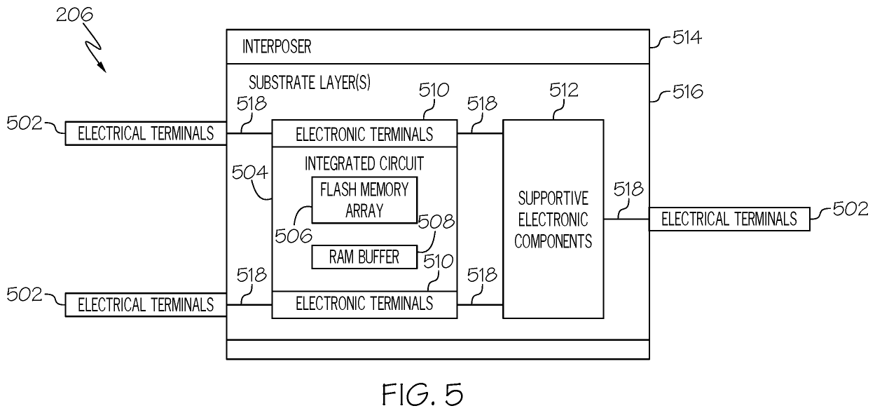

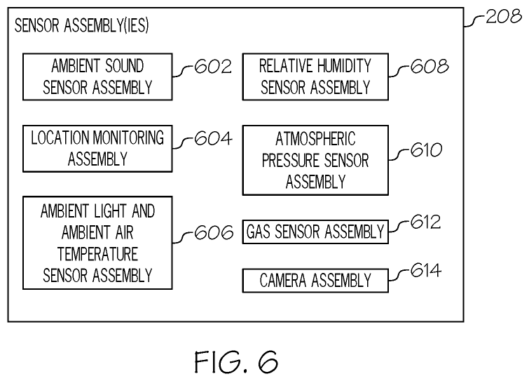

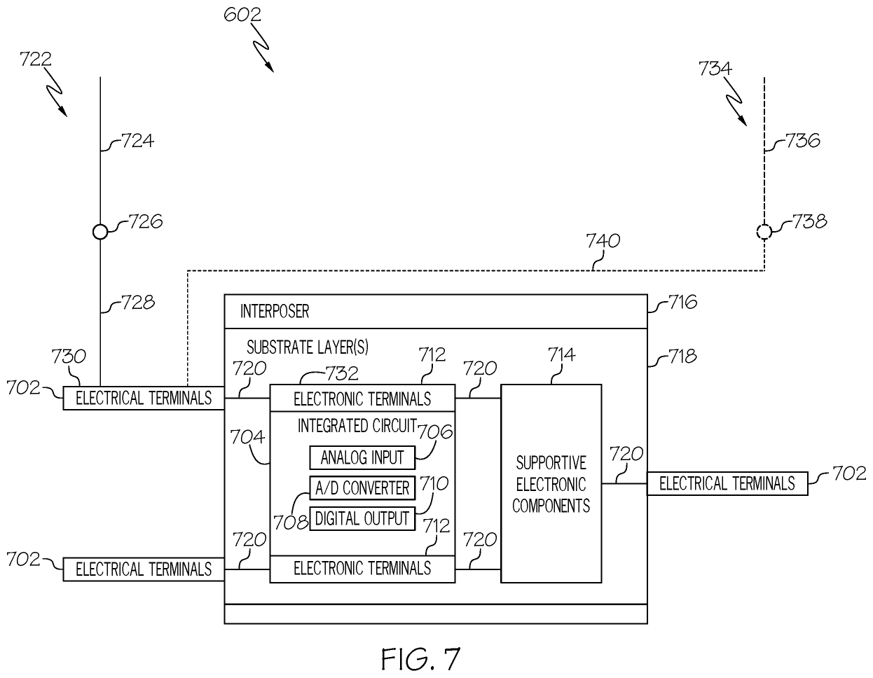

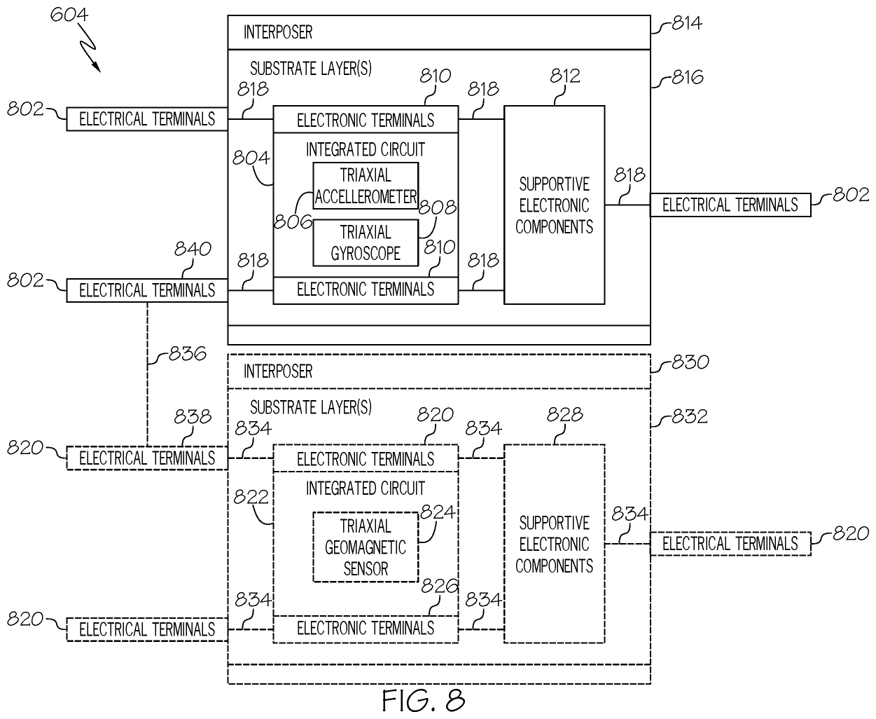

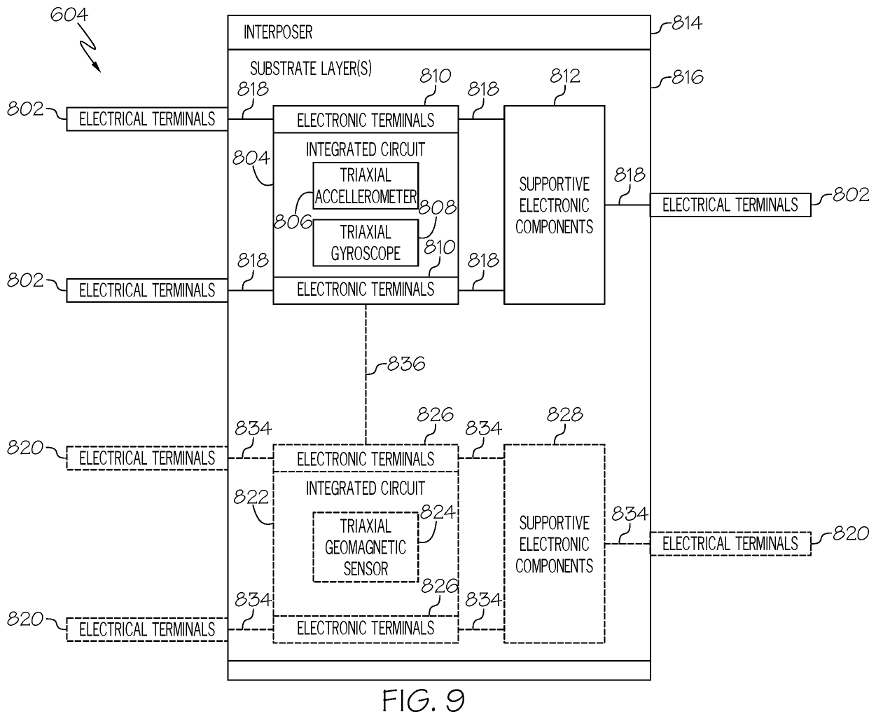

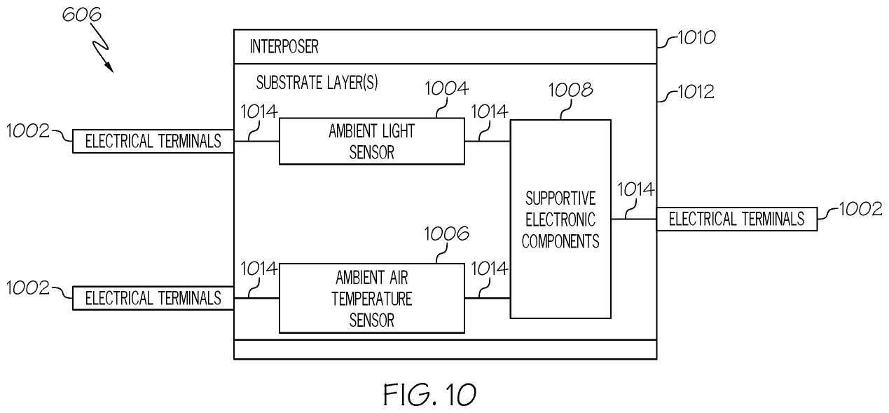

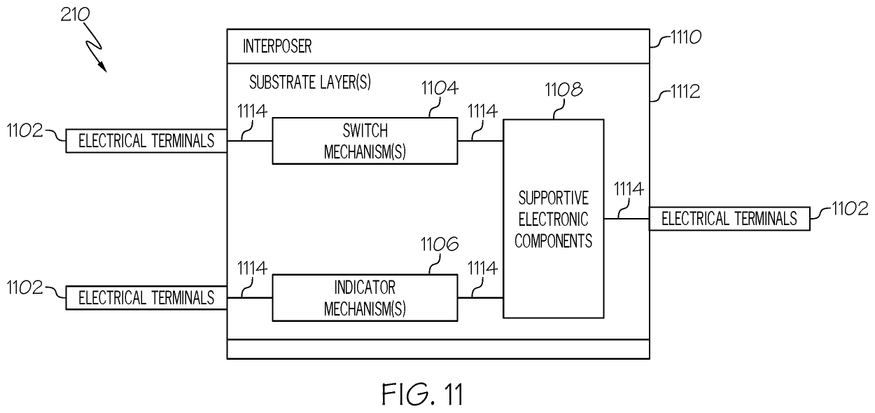

Referring generally to FIGS. 1A-D and 2-11, by way of examples, the present disclosure is directed to a wearable apparatus 100 that includes a garment 102a, 102b, 102c, 102d and a distributed electrical circuit 200. FIGS. 1A-D disclose several examples of the wearable apparatus 100. FIG. 2 discloses an example of the distributed electrical circuit 200. The distributed electrical circuit 200 includes a battery assembly 202, at least one microcontroller assembly 204, at least one memory assembly 206, at least one sensor assembly 208, at least one control assembly 210 and a plurality of conductors 212. FIG. 3 discloses an example of the battery assembly 202. FIG. 4 discloses an example of the microcontroller assembly 204. FIG. 5 discloses an example of the memory assembly 206. FIG. 6 discloses several examples of sensor assemblies 208. FIG. 7 discloses an example of an ambient sound sensor assembly 602. FIGS. 8 and 9 disclose several examples of a location monitoring assembly 604. FIG. 10 discloses an example of an ambient light and an ambient air temperature sensor assembly 606. FIG. 11 discloses an example of the control assembly 210.

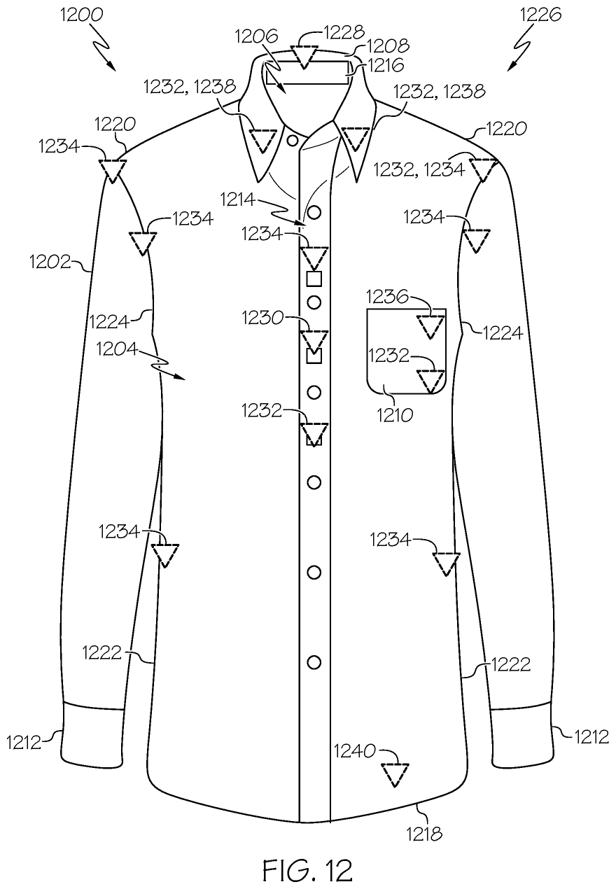

With reference again to FIGS. 1A-D and 2, in one or more examples, a wearable apparatus 100a, 100b, 100c, 100d includes a garment 102a, 102b, 102c, 102d and a distributed electrical circuit 200. The garment 102a, 102b, 102c, 102d is configured to be worn by a wearer. The garment 102a, 102b, 102c, 102d includes a visible outer face 104a, 104b, 104c, 104d directed away from the wearer and an inconspicuous inner face 106a, 106b, 106c, 106d directed toward the wearer. The garment 102a, 102b, 102c, 102d also includes at least one of (i) a collar 108a, 108c, (ii) a lapel 110d. (iii) a hood, (iv) at least one pocket 112a, 112b, 112d, (v) at least one cuff 114a, 114d, (vi) at least one placket 116a, 116b, 116c, 116d, (vii) at least one pouch 1216 (see FIG. 12), (viii) at least one lining 118d, (ix) at least one hem 120a, 120b, 120c. 120d, (x) at least one seam 122a, 122b, 122c, 122d and (xi) at least one double layered area 124a, 124d.

The distributed electrical circuit 200 inconspicuously integrated within the garment 102a, 102b, 102c. 102d. The distributed electrical circuit 200 includes a battery assembly 202, at least one microcontroller assembly 204, at least one memory assembly 206, at least one sensor assembly 208, at least one control assembly 210 and a plurality of conductors 212. The plurality of conductors 212 arranged to interconnect the battery assembly 202, the at least one microcontroller assembly 204, the at least one memory assembly 206, the at least one sensor assembly 208 and the at least one control assembly 210 to form the distributed electrical circuit 200. The battery assembly 202, the at least one microcontroller assembly 204, the at least one memory assembly 206, the at least one sensor assembly 208 and the at least one control assembly 210 are disposed in at least one of the collar 108a, 108c, the lapel 110d, the hood, the at least one pocket 112a, 112b, 112d, the at least one cuff 114a, 114d, the at least one placket 116a. 116b, 116c, 116d, the at least one pouch 1216, the at least one lining 118d, the at least one hem 120a, 120b, 120c. 120d, the at least one seam 122a, 122b, 122c. 122d and the at least one double layered area 124a, 124d.

In another example of the wearable apparatus 100, the garment 102a, 102b, 102c, 102d includes an article of clothing, a shirt, a dress shirt, a t-shirt, a sweatshirt, a sweater, a top, a pair of pants, a pair of dress pants, a pair of trousers, a pair of slacks, a pair of suit pants, a suit coat, a blazer, a sport coat, a vest, a jacket, a coat, a laboratory coat, an overcoat, a topcoat, a trench coat, a raincoat, or any suitable garment. In yet another example of the wearable apparatus 100, the wearer is an intelligence operator, a government agent, an undercover agent, a law enforcement officer, a security officer, a factory monitor, a compliance inspector, a quality assurance specialist, a certification specialist, a person requiring health or status monitoring, or any suitable person assigned to any suitable type of environmental monitoring.

In still another example of the wearable apparatus 100, the collar 108a, 108c includes a straight collar, a button-down collar, a tuxedo collar, a mandarin collar, a polo collar, a crew neck collar, a V neck collar, a roll collar, a flat collar, a stand collar, a Chelsea collar, a shawl collar, a turtle neck collar, a bow tie collar, a bib collar, a notched collar, a cowl collar, or any suitable collar. In still yet another example of the wearable apparatus 100, the lapel 110d includes a notch lapel, a peak lapel, a shawl lapel or any suitable lapel. In another example of the wearable apparatus 100, the at least one pocket 112a, 112b, 112d includes a breast pocket, a welt pocket, a side seam pocket, a jetted pocket, a flap pocket, an inside pocket, a slanted pocket, a patch pocket, a coin pocket, a utility pocket, a mechanic's pocket, a bellows pocket, a cargo pocket, a kangaroo pocket, or any suitable pocket in any suitable combination.

In yet another example of the wearable apparatus 100, the at least one cuff 114a, 114d includes a shirt cuff, a button cuff, a link cuff, a band cuff, a drawstring cuff, a rolled cuff, a gauntlet cuff, a loop cuff, a rib knit, cuff, a shirred cuff, a trouser cuff, a pants cuff, a jacket cuff, or any suitable cuff in any suitable combination. In still another example of the wearable apparatus 100, the at least one placket 116a, 116b, 116c. 116d includes a shirt placket, a partial placket, a blouse placket, a concealed placket, a false placket, a button placket, a zipper placket, a hook and eye placket, a hook and loop placket or any suitable placket in any suitable combination.

In still yet another example of the wearable apparatus 100, the at least one pouch 1216 (see FIG. 12) includes a fabric selected to match at least a related portion of the garment 102a. 102b, 102c. 102d. The fabric is sewn to form a container with a flap and a fastener. The flap is configured to open and close access to the container. The fastener is configured to at least temporarily secure the flap to the container. The at least one pouch 1216 is at least temporarily secured to the inconspicuous inner face 106a, 106b, 106c. 106d of the garment 102a, 102b, 102c. 102d. In a further example, a first pouch is configured to receive the battery assembly 202.

In another example of the wearable apparatus 100, the at least one lining 118d includes an inner layer of fabric forming at least a portion of the inconspicuous inner face 106a, 106b, 106c, 106d of the garment 102a, 102b, 102c. 102d, a collar lining, a hood lining, a pocket lining, a cuff lining, a pouch lining, or any suitable lining in any combination. In yet another example of the wearable apparatus 100, the at least one hem 120a, 120b, 120c, 120d includes a collar hem, a lapel hem, a hood hem, a pocket hem, a cuff hem, a placket hem, a pouch hem, a sleeve hem, a bottom hem or any suitable hem in any suitable combination.

In still another example of the wearable apparatus 100, the at least one seam 122a, 122b, 122c. 122d includes a side seam, a shoulder seam, a yoke seam, a central back seam, a central front seam, an armhole seam, a sleeve seam, an outer seam, an inner seam, a plain seam, a lapped seam, an abutted seam, a bound seam, a flat seam, a French seam, a superimposed seam, a piping seam, or any suitable seam in any suitable combination. In still yet another example of the wearable apparatus 100, the at least one double layered area 124a, 124d includes the collar 108a, 108c, the lapel (110d), the hood, the at least one pocket 112a, 112b, 112d, the at least one cuff 114a, 114d, the at least one placket 116a, 116b, 116c, 116d, an outer patch, an inner patch, or any suitable double layered area in any suitable combination.

In another example of the wearable apparatus 100, the plurality of conductors 212 include conductive threads, conductive fibers, conductive traces, conductive fabric pieces or any suitable conductor in any suitable combination. In yet another example of the wearable apparatus 100, the at least one memory assembly 206 includes at least one non-volatile memory assembly.

With reference again to FIGS. 2 and 3, in various examples of the wearable apparatus 100, an example of the battery assembly 202 includes a flexible, stretchable, conformable rechargeable battery 302, a positive terminal 310, a negative terminal 312 and a flexible, stretchable, conformable outer casing 314. The rechargeable battery 302 with an ionically conductive polymer-based electrolyte 304 between a positive electrode 306 and a negative electrode 308. The positive terminal 310 and the negative terminal 312 are in operative communication with the positive electrode 306 and the negative electrode 308. The outer casing 314 enclosing the battery 302.

With reference again to FIGS. 2 and 4, in various examples of the wearable apparatus 100, an example of the at least one microcontroller assembly 204 includes a plurality of electrical terminals 402, an integrated circuit 404, supportive electronic components 412, a flexible, stretchable, conformable interposer 414 and a plurality of conductive traces 418. The plurality of electrical terminals 402 configured to connect electrical signals of the distributed electrical circuit 200 with components of the at least one microcontroller assembly 204. The integrated circuit 404 includes at least one processor 406, associated memory 408 and electronic terminals 410 for electronic connections to and from the integrated circuit 404. The supportive electronic components 412 configured to condition electronic signals between the integrated circuit 404 and the plurality of electrical terminals 402. The interposer 414 includes at least one substrate layer 416 configured to receive and retain the integrated circuit 404, the supportive electronic components 412 and the plurality of electrical terminals 402. The integrated circuit 404 is disposed in a cavity of the at least one substrate layer 416 with the electronic terminals 410 facing away from the cavity. The plurality of conductive traces 418 deposited on the at least one substrate layer 416 of the interposer 414 and arranged to interconnect the electronic terminals 410 of the integrated circuit 404, the supportive electronic components 412 and the plurality of electrical terminals 402 for operation of the at least one microcontroller assembly 204.

As used herein, “electronic terminals” broadly refers to any type of electrical connection to any type of integrated circuit, electronic circuit, or electronic component. For example, “electronic terminals” include pins, pads, electrodes, leads, leadless pins, leadless pads and grid arrays.

In another example of the microcontroller assembly 204, the integrated circuit 404 includes an unpackaged electronic circuit. As used herein, an “unpackaged electronic circuit” broadly refers to integrated circuits that are not encapsulated in a supporting case. Unpackaged electronic circuits may also be referred to as non-packaged integrated circuits. For example, “unpackaged electronic circuit” includes chip-scale packages, true chip-size packages, true die-size packages, wafer-level chip-scale packages, power mount chip-scale packages, fan-out wafer-level chip-scale packages, embedded wafer level ball grid arrays, chips on board, chips-on-flex, chips-on-glass, chips on wire, tape-automated bonding chip-size packages and micro surface mount device chip-size packages.

In yet another example of the microcontroller assembly 204, the integrated circuit 404 includes a packaged electronic circuit. As used herein, a “packaged electronic circuit” broadly refers to integrated circuits that are encapsulated in a supporting case. Unpackaged electronic circuits may also be referred to as non-packaged integrated circuits.

In still another example of the microcontroller assembly 204, the at least one substrate layer 416 of the interposer 414 includes a stretchable and conformable low temperature thermoset polymeric material. For example, this material may include thermoplastic polyurethane (TPU), silicone, polyethylene (PE), low molecular weight polymethyl methacrylate (PMMA), polytetrafluoroethylene (PTFE), other fluoropolymers, and any other suitable stretchable and conformable low temperature thermoset polymeric material. In still yet another example of the microcontroller assembly 204, the plurality of conductive traces 418 deposited on the at least one substrate layer 416 include a printed conductive ink.

In another example of the microcontroller assembly 204, the interposer 414 also includes an upper substrate layer. The upper substrate layer configured to fuse with the at least one substrate layer 416 to form a flexible, stretchable, conformable outer casing enclosing the integrated circuit 404, the supportive electronic components 412 and the plurality of conductive traces 418 within the interposer 414 with the plurality of electrical terminals 402 accessible for connection of the at least one microcontroller assembly 204 to the distributed electrical circuit 200. In this example, the at least one microcontroller assembly 204 also includes a plurality of apertures through the at least one substrate layer 416 and the upper substrate layer. The plurality of apertures configured to improve breathability of the at least one microcontroller assembly 204, configured to vent heat generated by the wearer of the garment 102a, 102b, 102c, 102d and configured to wick moisture generated by the wearer of the garment 102a, 102b, 102c, 102d. The plurality of apertures are distributed throughout the at least one microcontroller assembly 204.

With reference again to FIGS. 2 and 5, in various examples of the wearable apparatus 100, an example of the at least one memory assembly 206 includes a plurality of electrical terminals 502, an integrated circuit 504, supportive electronic components 512, a flexible, stretchable, conformable interposer 514 and a plurality of conductive traces 518. The plurality of electrical terminals 502 configured to connect electrical signals of the distributed electrical circuit 200 with components of the at least one memory assembly 206. The integrated circuit 504 includes at least one flash memory array 506, a low leakage random-access memory (RAM) buffer 508 and electronic terminals 510 for electronic connections to and from the integrated circuit 504. The supportive electronic components 512 configured to condition electronic signals between the integrated circuit 504 and the plurality of electrical terminals 502. The interposer 514 includes at least one substrate layer 516 configured to receive and retain the integrated circuit 504, the supportive electronic components 512 and the plurality of electrical terminals 502. The integrated circuit 504 is disposed in a cavity of the at least one substrate layer 516 with the electronic terminals 510 facing away from the cavity. The plurality of conductive traces 518 deposited on the at least one substrate layer 516 of the interposer 514 and arranged to interconnect the electronic terminals 510 of the integrated circuit 504, the supportive electronic components 512 and the plurality of electrical terminals 502 for operation of the at least one memory assembly 206.

In another example of the memory assembly 206, the integrated circuit 504 includes an unpackaged electronic circuit. In yet another example of the memory assembly 206, the integrated circuit 504 includes a packaged electronic circuit. In still another example of the memory assembly 206, the at least one substrate layer 516 of the interposer 514 includes a stretchable and conformable low temperature thermoset polymeric material. For example, this material may include thermoplastic polyurethane (TPU), silicone, polyethylene (PE), low molecular weight polymethyl methacrylate (PMMA), polytetrafluoroethylene (PTFE), other fluoropolymers, and any other suitable stretchable and conformable low temperature thermoset polymeric material. In still yet another example of the memory assembly 206, the plurality of conductive traces 518 deposited on the at least one substrate layer 516 include a printed conductive ink.

In another example of the memory assembly 206, the interposer 514 also includes an upper substrate layer. The upper substrate layer configured to fuse with the at least one substrate layer 516 to form a flexible, stretchable, conformable outer casing enclosing the integrated circuit 504, the supportive electronic components 512 and the plurality of conductive traces 518 within the interposer 514 with the plurality of electrical terminals 502 accessible for connection of the at least one memory assembly 206 to the distributed electrical circuit 200. In this example, the at least one memory assembly 206 also includes a plurality of apertures through the at least one substrate layer 516 and the upper substrate layer. The plurality of apertures configured to improve breathability of the at least one memory assembly 206, configured to vent heat generated by the wearer of the garment 102a, 102b 102c. 102d and configured to wick moisture generated by the wearer of the garment 102a, 102b, 102c, 102d. The plurality of apertures are distributed throughout the at least one memory assembly 206.

With reference again to FIGS. 2 and 6, in various examples of the wearable apparatus 100, an example of the at least one sensor assembly 208 includes an ambient sound sensor assembly 602, a location monitoring assembly 604, an ambient light and ambient air temperature sensor assembly 606, a relative humidity sensor assembly 608, an atmospheric pressure sensor assembly 610, a gas sensor assembly 612, a camera assembly 614, or any suitable sensor assembly in any suitable combination.

With reference again to FIGS. 2, 6 and 7, in various examples of the wearable apparatus 100, an example of the ambient sound sensor assembly 602 includes a plurality of electrical terminals 702, an integrated circuit 704, supportive electronic components 714, a flexible, stretchable, conformable interposer 716, a plurality of conductive traces 720, a microphone 722 and an interface conductor 728. The plurality of electrical terminals 702 configured to connect electrical signals of the distributed electrical circuit 200 with components of the ambient sound sensor assembly 602. The integrated circuit 704 includes an analog audio input 706, at least one analog-to-digital converter 708, a digital audio output 710 and electronic terminals 712 for electronic connections to and from the integrated circuit 704. The supportive electronic components 714 configured to condition electronic signals between the integrated circuit 704 and the plurality of electrical terminals 702. The interposer 716 includes at least one substrate layer 718 configured to receive and retain the integrated circuit 704, the supportive electronic components 714 and the plurality of electrical terminals 702. The integrated circuit 704 is disposed in a cavity of the at least one substrate layer 718 with the electronic terminals 712 facing away from the cavity. The plurality of conductive traces 720 deposited on the at least one substrate layer 718 of the interposer 716 and arranged to interconnect the electronic terminals 712 of the integrated circuit 704, the supportive electronic components 714 and the plurality of electrical terminals 702 for operation of the ambient sound sensor assembly 602. The microphone 722 is configured to convert ambient sound waves into a first audio signal. The microphone 722 includes a termination 726 for distribution of the first audio signal. The interface conductor 728 configured to connect the termination 726 of the microphone 722 to the analog audio input 706 of the integrated circuit 704 via one or more electrical terminals 730 of the interposer 716 and one or more electronic terminals 732 of the integrated circuit 704.

In another example of the ambient sound sensor assembly 602, the integrated circuit 704 includes an unpackaged electronic circuit. In yet another example of the ambient sound sensor assembly 602, the integrated circuit 704 includes a packaged electronic circuit. In still another example of the ambient sound sensor assembly 602, the at least one substrate layer 718 of the interposer 716 includes a stretchable and conformable low temperature thermoset polymeric material. For example, this material may include thermoplastic polyurethane (TPU), silicone, polyethylene (PE), low molecular weight polymethyl methacrylate (PMMA), polytetrafluoroethylene (PTFE), other fluoropolymers, and any other suitable stretchable and conformable low temperature thermoset polymeric material. In still yet another example of the ambient sound sensor assembly 602, the plurality of conductive traces 720 deposited on the at least one substrate layer 718 include a printed conductive ink.

In another example of the ambient sound sensor assembly 602, the integrated circuit 704 also includes a digital signal processor. In yet another example of the ambient sound sensor assembly 602, the microphone 722 includes a flexible acoustic fiber 724. In this example, the acoustic fiber 724 includes a piezoelectric conductor and a flexible plastic coating. In still another example of the ambient sound sensor assembly 602, the microphone 722 includes an electronically packaged microphone. In this example, the electronically packaged microphone includes piezoelectric material and a flexible plastic coating. In still yet another example of the ambient sound sensor assembly 602, the interface conductor 728 includes a conductive thread, a conductive fiber, a conductive trace, or any suitable conductor in any suitable combination.

In another example of the ambient sound sensor assembly 602, the interposer 716 also includes an upper substrate layer. The upper substrate layer configured to fuse with the at least one substrate layer 718 to form a flexible, stretchable, conformable outer casing enclosing the integrated circuit 704, the supportive electronic components 714 and the plurality of conductive traces 720 within the interposer 716 with the plurality of electrical terminals 702 accessible for connection of the ambient sound sensor assembly 602 to the distributed electrical circuit 200. In this example, the ambient sound sensor assembly 602 also includes a plurality of apertures through the at least one substrate layer 718 and the upper substrate layer. The plurality of apertures configured to improve breathability of the ambient sound sensor assembly 602, configured to vent heat generated by the wearer of the garment 102a, 102b, 102c, 102d and configured to wick moisture generated by the wearer of the garment 102a, 102b, 102c, 102d. The plurality of apertures are distributed throughout the ambient sound sensor assembly 602.

In yet another example, the ambient sound sensor assembly 602 also includes a second microphone 734 and a second interface conductor 740. The second microphone 734 is configured to convert the ambient sound waves into a second audio signal. The second microphone 734 includes a second termination 738 for distribution of the second audio signal. The second interface conductor 740 configured to connect the second termination 738 of the second microphone 740 to the analog audio input 706 of the integrated circuit via the one or more electrical terminals 730 of the interposer 716 and the one or more electronic terminals 732 of the integrated circuit 704. In a further example, the integrated circuit 704 is configured to operate in a stereo mode that merges the first audio signal and the second audio signal. In this example, the digital audio output 710 is a stereo audio output. In another further example, the second microphone 734 includes a flexible acoustic fiber 736. In this example, the acoustic fiber 736 includes a piezoelectric conductor and a flexible plastic coating. In yet another further example, the second microphone 734 includes an electronically packaged microphone. In this example, the electronically packaged microphone includes piezoelectric material and a flexible plastic coating.

With reference again to FIGS. 2, 6 and 8, in various examples of the wearable apparatus 100, an example of the location monitoring assembly 604 includes a first plurality of electrical terminals 802, a first integrated circuit 804, first supportive electronic components 812, a flexible, stretchable, conformable first interposer 814 and a first plurality of conductive traces 818. The first plurality of electrical terminals 802 configured to connect electrical signals of the distributed electrical circuit 200 with first components of the location monitoring assembly 604. The first integrated circuit 804 includes a triaxial accelerometer 806, a triaxial gyroscope 808 and first electronic terminals 810 for first electronic connections to and from the first integrated circuit 804. The first supportive electronic components 812 configured to condition first electronic signals between the first integrated circuit 804 and the first plurality of electrical terminals 802. The first interposer 814 includes a first at least one substrate layer 816 configured to receive and retain the first integrated circuit 804, the first supportive electronic components 812 and the first plurality of electrical terminals 802. The first integrated circuit 804 is disposed in a first cavity of the first at least one substrate layer 816 with the first electronic terminals 810 facing away from the first cavity. The first plurality of conductive traces 818 deposited on the first at least one substrate layer 816 of the first interposer 814 and arranged to interconnect the first electronic terminals 810 of the first integrated circuit 804, the first supportive electronic components 812 and the first plurality of electrical terminals 802 for operation of the location monitoring assembly 604.

In another example of the location monitoring assembly 604, the first integrated circuit 804 includes an unpackaged electronic circuit. In yet another example of the location monitoring assembly 604, the first integrated circuit 804 includes a packaged electronic circuit. In still another example of the location monitoring assembly 604, the first at least one substrate layer 816 of the first interposer 814 includes a stretchable and conformable low temperature thermoset polymeric material. For example, this material may include thermoplastic polyurethane (TPU), silicone, polyethylene (PE), low molecular weight polymethyl methacrylate (PMMA), polytetrafluoroethylene (PTFE), other fluoropolymers, and any other suitable stretchable and conformable low temperature thermoset polymeric material. In still yet another example of the location monitoring assembly 604, the first plurality of conductive traces 818 deposited on the first at least one substrate layer 816 include a printed conductive ink.

In another example of the location monitoring assembly 604, the first interposer 814 also includes an upper substrate layer. The upper substrate layer configured to fuse with the first at least one substrate layer 816 to form a flexible, stretchable, conformable outer casing enclosing the first integrated circuit 804, the first supportive electronic components 812 and the first plurality of conductive traces 818 within the first interposer 814 with the first plurality of electrical terminals 802 accessible for connection of the location monitoring assembly 604 to the distributed electrical circuit 200. In this example, the location monitoring assembly 604 also includes a plurality of apertures through the first at least one substrate layer 816 and the upper substrate layer. The plurality of apertures configured to improve breathability of the location monitoring assembly 604, configured to vent heat generated by the wearer of the garment 102a, 102b, 102c, 102d and configured to wick moisture generated by the wearer of the garment 102a, 102b, 102c, 102d. The plurality of apertures are distributed throughout the location monitoring assembly 604.

In yet another example, the location monitoring assembly 604 also includes a second plurality of electrical terminals 820, a second integrated circuit 822, second supportive electronic components 828, a flexible, stretchable, conformable second interposer 830, a second plurality of conductive traces 834 and at least one interface conductor 836. The second plurality of electrical terminals 820 configured to connect electrical signals of the distributed electrical circuit 200 with second components of the location monitoring assembly 604. The second integrated circuit 822 includes a triaxial geomagnetic sensor 824 and second electronic terminals 826 for second electronic connections to and from the second integrated circuit 822. The second supportive electronic components 828 configured to condition second electronic signals between the second integrated circuit 822 and the second plurality of electrical terminals 820. The second interposer 830 includes a second at least one substrate layer 832 configured to receive and retain the second integrated circuit 822, the second supportive electronic components 828 and the second plurality of electrical terminals 820. The second integrated circuit 822 is disposed in a second cavity of the second at least one substrate layer 832 with the second electronic terminals 826 facing away from the second cavity. The second plurality of conductive traces 834 deposited on the second at least one substrate layer 832 of the second interposer 830 and arranged to interconnect the second electronic terminals 826 of the second integrated circuit 834, the second supportive electronic components 828 and the second plurality of electrical terminals 820 for operation of the location monitoring assembly 604. The least one interface conductor 836 configured to connect at least a portion 838 of the second plurality of electrical terminals 820 associated with the second interposer 830 to at least a portion 840 of the first plurality the electrical terminals 802 associated with the first interposer 814 to connect one or more geomagnetic output signal of the second integrated circuit 822 to one or more auxiliary input signal of the first integrated circuit 804.

In a further example of the location monitoring assembly 604, the second integrated circuit 822 includes an unpackaged electronic circuit. In another further example, the second integrated circuit 822 includes a packaged electronic circuit. In yet another further example, the second at least one substrate layer 832 of the second interposer 830 includes a stretchable and conformable low temperature thermoset polymeric material. For example, this material may include thermoplastic polyurethane (TPU), silicone, polyethylene (PE), low molecular weight polymethyl methacrylate (PMMA), polytetrafluoroethylene (PTFE), other fluoropolymers, and any other suitable stretchable and conformable low temperature thermoset polymeric material. In still another further example, the second plurality of conductive traces 834 deposited on the second at least one substrate layer 832 include a printed conductive ink.

In still yet another further example of the location monitoring assembly 604, the second interposer 830 also includes an upper substrate layer. The upper substrate layer configured to fuse with the second at least one substrate layer 832 to form a flexible, stretchable, conformable outer casing enclosing the second integrated circuit 822, the second supportive electronic components 828 and the second plurality of conductive traces 834 within the second interposer 830 with the second plurality of electrical terminals 820 accessible for connection of the location monitoring assembly 604 to the distributed electrical circuit 200. In this example, the location monitoring assembly 604 also includes a plurality of apertures through the second at least one substrate layer 832 and the upper substrate layer. The plurality of apertures configured to improve breathability of the location monitoring assembly 604, configured to vent heat generated by the wearer of the garment 102a. 102b, 102c, 102d and configured to wick moisture generated by the wearer of the garment 102a, 102b, 102c, 102d. The plurality of apertures are distributed throughout the location monitoring assembly 604.

With reference again to FIGS. 2, 6 and 9, in various examples of the wearable apparatus 100, another example of the location monitoring assembly 604 is shown in FIG. 9 in which the second plurality of electrical terminals 820, the second integrated circuit 822, the second supportive electronic components 828, the second plurality of conductive traces 834 and the at least one interface conductor 836 are integrated within the first at least one substrate layer 816 of the first interposer 814.

With reference again to FIGS. 2, 6 and 10, in various examples of the wearable apparatus 100, an example of the ambient light and ambient air temperature sensor assembly 606 includes a plurality of electrical terminals 1002, an ambient light sensor 1004, an ambient air temperature sensor 1006, supportive electronic components 1008, a flexible, stretchable, conformable interposer 1010 and a plurality of conductive traces 1014. The plurality of electrical terminals 1002 configured to connect electrical signals of the distributed electrical circuit 200 with components of the ambient light and ambient air temperature sensor assembly 606. The ambient light sensor 1004 configured to convert local light exposure to a light measurement signal. The ambient air temperature sensor 1006 is configured to convert local temperature exposure to a temperature measurement signal. The supportive electronic components 1008 configured to condition the light and temperature measurement signals between the ambient light and ambient air temperature sensors 1004, 1006 and the plurality of electrical terminals 1002. The interposer 1010 includes at least one substrate layer 1012 configured to receive and retain the ambient light sensor 1004, the ambient air temperature sensor 1006 and the supportive electronic components 1008 and the plurality of electrical terminals 1002. The plurality of conductive traces 1014 deposited on the at least one substrate layer 1012 of the interposer 1010 and arranged to interconnect the ambient light sensor 1004, the ambient air temperature sensor 1006, the supportive electronic components 1008 and the plurality of electrical terminals 1002 for operation of the ambient light and ambient air temperature sensor assembly 606.

In another example of the ambient light and ambient air temperature sensor assembly 604, the at least one substrate layer 1012 of the interposer 1010 includes a stretchable and conformable low temperature thermoset polymeric material. For example, this material may include thermoplastic polyurethane (TPU), silicone, polyethylene (PE), low molecular weight polymethyl methacrylate (PMMA), polytetrafluoroethylene (PTFE), other fluoropolymers, and any other suitable stretchable and conformable low temperature thermoset polymeric material. In yet another example of the ambient light and ambient air temperature sensor assembly 604, the plurality of conductive traces 1014 deposited on the at least one substrate layer 1012 include a printed conductive ink.

In still another example of the ambient light and ambient air temperature sensor assembly 604, the interposer 1010 also includes an upper substrate layer. The upper substrate layer configured to fuse with the at least one substrate layer 1012 to form a flexible, stretchable, conformable outer casing enclosing the ambient light sensor 1004, the ambient air temperature sensor 1006, the supportive electronic components 1008 and the plurality of conductive traces 1014 within the interposer 1010 with the plurality of electrical terminals 1002 accessible for connection of the ambient light and ambient air temperature sensor assembly 606 to the distributed electrical circuit 200. In this example, the ambient light and ambient air temperature sensor assembly 606 also includes a plurality of apertures through the at least one substrate layer 1012 and the upper substrate layer. The plurality of apertures configured to improve breathability of the ambient light and ambient air temperature sensor assembly 606, configured to vent heat generated by the wearer of the garment 102a, 102b, 102c, 102d and configured to wick moisture generated by the wearer of the garment 102a, 102b, 102c, 102d. The plurality of apertures are distributed throughout the ambient light and ambient air temperature sensor assembly 606.

With reference again to FIGS. 2 and 11, in various examples of the wearable apparatus 100, an example of the at least one control assembly 210 includes a plurality of electrical terminals 1102, at least one switch mechanism 1104, at least one indicator mechanism 1106, supportive electronic components 1108, a flexible, stretchable, conformable interposer 1110 and a plurality of conductive traces 1114. The plurality of electrical terminals 1102 configured to connect electrical signals of the distributed electrical circuit 200 with components of the at least one control assembly 210. The at least one switch mechanism 1104 configured to enable and control the distributed electrical circuit 200. The at least one indicator mechanism 1106 configured to indicate at least one status condition of the distributed electrical circuit 200. The supportive electronic components 1108 configured to condition control signals between the at least one switch mechanism 1104, the at least one indicator mechanism 1106 and the plurality of electrical terminals 1102. The interposer 1110 includes at least one substrate layer 1112 configured to receive and retain the at least one switch mechanism 1104, the at least one indicator mechanism 1106, the supportive electronic components 1108 and the plurality of electrical terminals 1102. The plurality of conductive traces 1114 deposited on the at least one substrate layer 1112 of the interposer 1110 and arranged to interconnect the at least one switch mechanism 1104, the at least one indicator mechanism 1106, the supportive electronic components 1108 and the plurality of electrical terminals 1102 for operation of the at least one control assembly 210.

In another example of the control assembly 210, the at least one substrate layer 1112 of the interposer 1110 includes a stretchable and conformable low temperature thermoset polymeric material. For example, this material may include thermoplastic polyurethane (TPU), silicone, polyethylene (PE), low molecular weight polymethyl methacrylate (PMMA), polytetrafluoroethylene (PTFE), other fluoropolymers, and any other suitable stretchable and conformable low temperature thermoset polymeric material.

In yet another example of the control assembly 210, the plurality of conductive traces 1114 deposited on the at least one substrate layer 1112 include a printed conductive ink.

In still another example of the control assembly 210, the interposer 1110 also includes an upper substrate layer configured to fuse with the at least one substrate layer 1112 to form a flexible, stretchable, conformable outer casing enclosing the at least one switch mechanism 1104, the at least one indicator mechanism 1106, the supportive electronic components 1108 and the plurality of conductive traces 1114 within the interposer 1110 with the plurality of electrical terminals 1102 accessible for connection of the at least one control assembly 210 to the distributed electrical circuit 200. In this example, the at least one control assembly 210 also includes a plurality of apertures through the at least one substrate layer 1112 and the upper substrate layer. The plurality of apertures configured to improve breathability of the at least one control assembly 210, configured to vent heat generated by the wearer of the garment 102a, 102b, 102c, 102d and configured to wick moisture generated by the wearer of the garment 102a, 102b, 102c, 102d. The plurality of apertures are distributed throughout the at least one control assembly 210.

In another example of the wearable apparatus 100, the distributed electrical circuit 200 also includes an open face magnetic connector interface 214 in operative communication with the at least one microcontroller assembly 204. The at least one microcontroller assembly 204 and the open face magnetic connector interface 214 are configured for data communication with an external device having a compatible open face magnetic connector.

In yet another example of the wearable apparatus 100, the distributed electrical circuit 200 also includes an open face magnetic connector interface 214 in operative communication with the battery assembly 202. The open face magnetic connector interface 214 configured to receive electrical power to recharge the battery assembly 202 from an external device having a compatible open face magnetic connector.

In still another example of the wearable apparatus 100, the distributed electrical circuit 200 also includes an electromagnetic interference (EMI) coating configured to shield the distributed electrical circuit 200 from EMI and configured to reduce EMI emissions from the distributed electrical circuit 200.

In still yet another example of the wearable apparatus 100, the distributed electrical circuit 200 also includes a hydrophobic coating configured to reduce risks of damage and degradation of the distributed electrical circuit 200 from exposure to rain, machine washing, water and other liquids.

With reference to FIG. 12, in one or more examples, a wearable apparatus 1200 includes a shirt 1202 and a distributed electrical circuit 1226. The shirt 1202 is configured to be worn by a wearer. The shirt 1202 includes a visible outer face 1204 directed away from the wearer and an inconspicuous inner face 1206 directed toward the wearer. The shirt 1202 also includes a pointed collar 1208, a patch pocket 1210, sleeve cuffs 1212, a button placket 1214, a pouch 1216, a bottom hem 1218, top seams 1220, side seams 1222 and armhole seams 1224. The distributed electrical circuit 1226 inconspicuously integrated within the shirt 1202. The distributed electrical circuit 1226 includes a battery assembly 1228, a microcontroller assembly 1230, at least one memory assembly 1232, an ambient sound sensor assembly 1234, a location monitoring assembly 1236, an ambient light and ambient air temperature assembly 1238, a control assembly 1240 and a plurality of conductors 1242. The plurality of conductors 1242 arranged to interconnect the battery assembly 1228, the microcontroller assembly 1230, the at least one memory assembly 1232, the ambient sound sensor assembly 1234, the location monitoring assembly 1236, the ambient light and ambient air temperature assembly 1238 and the control assembly 1240 to form the distributed electrical circuit 1226.

In another example of the wearable apparatus 1200, the distributed electrical circuit 1226 also includes a camera assembly 614 (see FIG. 6). In yet another example of the wearable apparatus 1200, the battery assembly 1228 is disposed in the pointed collar 1208 of the shirt 1202. In still another example of the wearable apparatus 1200, the microcontroller assembly 1230 is disposed in an upper portion of the button placket 1214 of the shirt 1202.

In still yet another example of the wearable apparatus 1200, the at least one memory assembly 1232 includes at least four memory assemblies disposed under pointed portions of the pointed collar 1208, in an upper portion of the button placket 1214, in relation to the top seams 1220 and the armhole seams 1224 and in or behind the patch pocket 1210 of the shirt 1202. In another example of the wearable apparatus 1200, the at least one memory assembly 1232 includes at least one non-volatile memory assembly.

In yet another example of the wearable apparatus 1200, a first portion of the ambient sound sensor assembly 1234 is disposed in relation to the side and armhole seams 1222, 1224 and a second portion is disposed in an upper portion of the button placket 1214 of the shirt 1202. In still another example of the wearable apparatus 1200, the location monitoring assembly 1236 is disposed in or behind the patch pocket 1210 of the shirt 1202.

In still yet another example of the wearable apparatus 1200, the ambient light and ambient air temperature assembly 1238 is disposed under pointed portions of the pointed collar 1208 of the shirt 1202. In another example of the wearable apparatus 1200, the control assembly 1240 is disposed along the bottom hem 1218 of the shirt 1202.

In yet another example of the wearable apparatus 1200, the plurality of conductors 1242 are at least one of interwoven within fabric pieces that form the shirt 1202, embedded within the pointed collar 1208, embedded within the button placket 1214, tucked in the pouch 1216, embedded within the bottom hem 1218, embedded within the top seams 1220, embedded within the side seams 1222, embedded within the armhole seams 1224 and embedded within paths of a stretchable and conformable low temperature thermoset polymeric material fused to the inconspicuous inner face 1206 of the shirt 1202. For example, this material may include thermoplastic polyurethane (TPU), silicone, polyethylene (PE), low molecular weight polymethyl methacrylate (PMMA), polytetrafluoroethylene (PTFE), other fluoropolymers, and any other suitable stretchable and conformable low temperature thermoset polymeric material.

With reference FIGS. 1, 2 and 13, in one or more examples, a method 1300 of manufacturing a wearable apparatus 100 begins at 1302 where fabric pieces used to form a garment 102a, 102b, 102c, 102d are obtained. The garment 102a, 102b, 102c, 102d is configured to be worn by a wearer. The garment 102a, 102b, 102c, 102d includes a visible outer face 104a, 104b, 104c. 104d directed away from the wearer and an inconspicuous inner face 106a, 106b, 106c, 106d directed toward the wearer. At 1304, a battery assembly 202, at least one microcontroller assembly 204, at least one memory assembly 206, at least one sensor assembly 208, at least one control assembly 210 used in a distributed electrical circuit 200 are obtained. At 1306, locations are selected in the garment 102a, 102b, 102c. 102d to inconspicuously integrate the battery assembly 202, the at least one microcontroller assembly 204, the at least one memory assembly 206, the at least one sensor assembly 208 and the at least one control assembly 210 from candidate locations. The candidate locations include (i) a collar 108a, 108c, (ii) a lapel 110d, (iii) a hood, (iv) at least one pocket 112a, 112b, 112d, (v) at least one cuff 114a, 114d, (vi) at least one placket 116a, 116b, 116c. 116d, (vii) at least one pouch 1216 (see FIG. 12), (viii) at least one lining 118d, (ix) at least one hem 120a, 120b, 120c, 120d. (x) at least one seam 122a, 122b, 122c, 122d and (xi) at least one double layered area 124a, 124d.

In another example of the method 1300, the at least one memory assembly 206 includes a at least one non-volatile memory assembly.

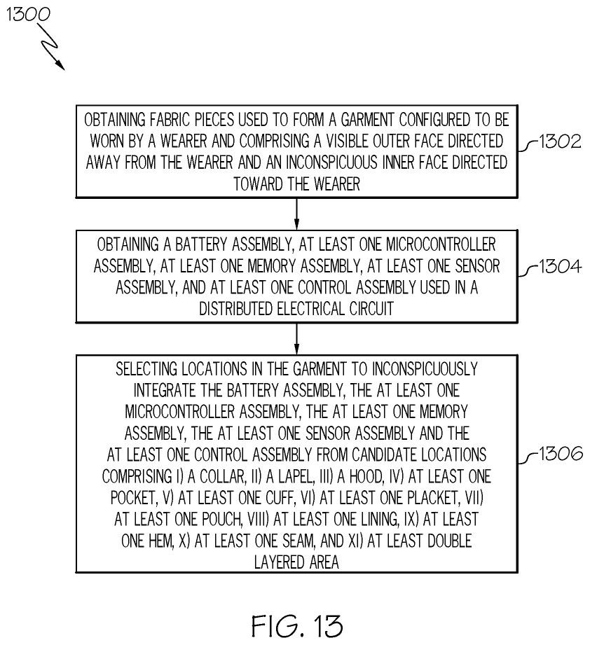

With reference FIGS. 1, 2, 13 and 14, in one or more examples, a method 1400 of manufacturing a wearable apparatus 100 includes the method 13 of FIG. 13 and continues from 1306 to 1402 where a plurality of conductors 212 are obtained to interconnect the battery assembly 202, the at least one microcontroller assembly 204, the at least one memory assembly 206, the at least one sensor assembly 208 and the at least one control assembly 210 to form the distributed electrical circuit 200. At 1404, locations are selected in the garment 102a, 102b, 102c, 102d to inconspicuously integrate the plurality of conductors 212 from the candidate locations. At 1406, manufacturing processes are selected to inconspicuously integrate the plurality of conductors 212 in the selected locations, wherein candidate manufacturing processes include (i) interweaving within the fabric pieces, (ii) routing within the at least one lining 118d, (iii) tucking within the at least one pocket 112a, 112b, 112d, the at least one pouch 1216 (see FIG. 12) and the at least one double layered area 124a, 124d and iv) embedding within the collar 108a, 108c, the lapel 110d, the hood, the at least one cuff 114a, 114d, the at least one placket 116a, 116b, 116c, 116d, the at least one hem 120a, 120b, 120c, 120d, the at least one seam 122a, 122b, 122c, 122d and within paths of a stretchable and conformable low temperature thermoset polymeric material fused to the inconspicuous inner face 106 of the garment 102a, 102b, 102c, 102d. At 1408, the garment (102a, 102b, 102c, 102d) is constructed from the fabric pieces and the distributed electrical circuit 200 based on the selected locations and the selected manufacturing processes. For example, this material may include thermoplastic polyurethane (TPU), silicone, polyethylene (PE), low molecular weight polymethyl methacrylate (PMMA), polytetrafluoroethylene (PTFE), other fluoropolymers, and any other suitable stretchable and conformable low temperature thermoset polymeric material.

Examples of the wearable apparatus 100, 1200 and associated methods 1300, 1400 may be related to, or used in the context of garments for adult male wearers. Although an adult male wearer example is described, the examples and principles disclosed herein may be applied to an adult female wearer, a minor wearer and any other wearer.

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic and/or operational step described in connection with the example is included in at least one aspect, embodiment and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels and are not intended to impose ordinal, positional, or hierarchical requirements on the items to which these terms refer. Moreover, reference to, e.g., a “second” item does not require or preclude the existence of, e.g., a “first” or lower-numbered item and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B and item C” may include, without limitation, item A or item A and item B. This example also may include item A, item B and item C, or item B and item C. In other examples, “at least one of” may be, for example, without limitation, two of item A, one of item B and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1A-D and 2-12, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features and/or components described and illustrated in FIGS. 1A-D and 2-12, referred to above, need be included in every example and not all elements, features and/or components described herein are necessarily depicted in each illustrative example. Accordingly, some of the elements, features and/or components described and illustrated in FIGS. 1A-D and 2-12 may be combined in various ways without the need to include other features described and illustrated in FIGS. 1A-D and 2-12, other drawing figures and/or the accompanying disclosure, even though such combination or combinations are not explicitly illustrated herein. Similarly, additional features not limited to the examples presented, may be combined with some or all the features shown and described herein. Unless otherwise explicitly stated, the schematic illustrations of the examples depicted in FIGS. 1A-D and 2-12, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features and/or components that serve a similar, or at least substantially similar, purpose are labeled with like numbers in each of FIGS. 1A-D and 2-12 and such elements, features and/or components may not be discussed in detail herein with reference to each of FIGS. 1A-D and 2-12. Similarly, all elements, features and/or components may not be labeled in each of FIGS. 1A-D and 2-12, but reference numerals associated therewith may be utilized herein for consistency.

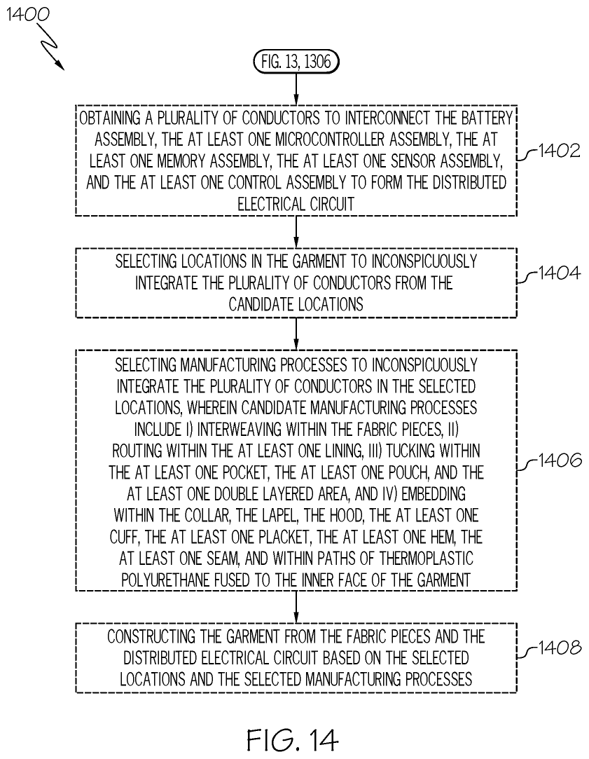

In FIGS. 13 and 14, referred to above, the blocks may represent operations, steps and/or portions thereof and lines connecting the various blocks do not imply any particular order or dependency of the operations or portions thereof. It will be understood that not all dependencies among the various disclosed operations are necessarily represented. FIGS. 13 and 14 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages and similar language used throughout the present disclosure may, but does not necessarily, refer to the same example.

The described features, advantages and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the wearable apparatus 100, 1200 and associated methods 1300, 1400 have been shown and described, modifications may occur to those skilled in the art upon reading the specification. The present application includes such modifications and is limited only by the scope of the claims.

1. A wearable apparatus, the wearable apparatus comprising:
a garment configured to be worn by a wearer and comprising a visible outer face directed away from the wearer and an inconspicuous inner face directed toward the wearer, the garment further comprising at least one of (i) a collar, (ii) a lapel, (iii) a hood, (iv) at least one pocket, (v) at least one cuff, (vi) at least one placket, (vii) at least one pouch, (viii) at least one lining, (ix) at least one hem, (x) at least one seam and (xi) at least one double layered area;
a distributed electrical circuit inconspicuously integrated within the garment, the distributed electrical circuit comprising:
a battery assembly;
at least one microcontroller assembly;
at least one memory assembly;
at least one sensor assembly;
at least one control assembly; and
a plurality of conductors arranged to interconnect the battery assembly, the at least one microcontroller assembly, the at least one memory assembly, the at least one sensor assembly and the at least one control assembly to form the distributed electrical circuit and
wherein the battery assembly, the at least one microcontroller assembly, the at least one memory assembly, the at least one sensor assembly and the at least one control assembly are disposed in at least one of the collar, the lapel, the hood, the at least one pocket, the at least one cuff, the at least one placket, the at least one pouch, the at least one lining, the at least one hem, the at least one seam and the at least one double layered area.

2. The wearable apparatus of claim 1, wherein the garment comprises at least one of an article of clothing, a shirt, a dress shirt, a t-shirt, a sweatshirt, a sweater, a top, a pair of pants, a pair of dress pants, a pair of trousers, a pair of slacks, a pair of suit pants, a suit coat, a blazer, a sport coat, a vest, a jacket, a coat, a laboratory coat, an overcoat, a topcoat, a trench coat and a raincoat.

3-7. (canceled)

8. The wearable apparatus of claim 1, wherein the at least one placket comprises one or more of a shirt placket, a partial placket, a blouse placket, a concealed placket, a false placket, a button placket, a zipper placket, a hook and eye placket and a hook and loop placket.

9-14. (canceled)

15. The wearable apparatus of claim 1, wherein the plurality of conductors comprise at least one of conductive threads, conductive fibers, conductive traces and conductive fabric pieces.

16. The wearable apparatus of claim 1, wherein the at least one memory assembly comprises at least one non-volatile memory assembly.

17. The wearable apparatus of claim 1, the battery assembly comprising:
a flexible, stretchable, conformable rechargeable battery with an ionically conductive polymer-based electrolyte between a positive electrode and a negative electrode;
a positive terminal and a negative terminal in operative communication with the positive electrode and the negative electrode; and
a flexible, stretchable, conformable outer casing enclosing the battery.

18. The wearable apparatus of claim 1, the at least one microcontroller assembly comprising:
a plurality of electrical terminals configured to connect electrical signals of the distributed electrical circuit with components of the at least one microcontroller assembly;
an integrated circuit comprising at least one processor, associated memory and electronic terminals for electronic connections to and from the integrated circuit;
supportive electronic components configured to condition electronic signals between the integrated circuit and the plurality of electrical terminals;
a flexible, stretchable, conformable interposer comprising at least one substrate layer configured to receive and retain the integrated circuit, the supportive electronic components and the plurality of electrical terminals, wherein the integrated circuit (404) is disposed in a cavity of the at least one substrate layer with the electronic terminals facing away from the cavity; and
a plurality of conductive traces deposited on the at least one substrate layer of the interposer and arranged to interconnect the electronic terminals of the integrated circuit, the supportive electronic components and the plurality of electrical terminals for operation of the at least one microcontroller assembly.

19-23. (canceled)

24. The wearable apparatus of claim 1, the at least one memory assembly comprising:
a plurality of electrical terminals configured to connect electrical signals of the distributed electrical circuit with components of the at least one memory assembly;
an integrated circuit comprising at least one flash memory array, a low leakage random-access memory (RAM) buffer and electronic terminals for electronic connections to and from the integrated circuit;
supportive electronic components configured to condition electronic signals between the integrated circuit and the plurality of electrical terminals;
a flexible, stretchable, conformable interposer comprising at least one substrate layer configured to receive and retain the integrated circuit, the supportive electronic components and the plurality of electrical terminals, wherein the integrated circuit is disposed in a cavity of the at least one substrate layer with the electronic terminals facing away from the cavity; and
a plurality of conductive traces deposited on the at least one substrate layer of the interposer and arranged to interconnect the electronic terminals of the integrated circuit, the supportive electronic components and the plurality of electrical terminals for operation of the at least one memory assembly.

25-29. (canceled)

30. The wearable apparatus of claim 1, the at least one sensor assembly comprising:
an ambient sound sensor assembly;
a location monitoring assembly;
an ambient light and ambient air temperature sensor assembly;
a relative humidity sensor assembly;
an atmospheric pressure sensor assembly;
a gas sensor assembly; and
a camera assembly.

31. The wearable apparatus of claim 30, the ambient sound sensor assembly comprising:
a plurality of electrical terminals configured to connect electrical signals of the distributed electrical circuit with components of the ambient sound sensor assembly;
an integrated circuit comprising an analog audio input, at least one analog-to-digital converter, a digital audio output and electronic terminals for electronic connections to and from the integrated circuit;
supportive electronic components configured to condition electronic signals between the integrated circuit and the plurality of electrical terminals;
a flexible, stretchable, conformable interposer comprising at least one substrate layer configured to receive and retain the integrated circuit, the supportive electronic components and the plurality of electrical terminals, wherein the integrated circuit is disposed in a cavity of the at least one substrate layer with the electronic terminals facing away from the cavity;
a plurality of conductive traces deposited on the at least one substrate layer of the interposer and arranged to interconnect the electronic terminals of the integrated circuit, the supportive electronic components and the plurality of electrical terminals for operation of the ambient sound sensor assembly;
a microphone configured to convert ambient sound waves into a first audio signal and comprising a termination for distribution of the first audio signal; and
an interface conductor configured to connect the termination of the microphone to the analog audio input of the integrated circuit via one or more electrical terminals of the interposer and one or more electronic terminals of the integrated circuit.

32. The wearable apparatus of claim 31, the ambient sound sensor assembly further comprising:
a second microphone configured to convert the ambient sound waves into a second audio signal and comprising a second termination for distribution of the second audio signal; and
a second interface conductor configured to connect the second termination of the second microphone to the analog audio input of the integrated circuit via the one or more electrical terminals of the interposer and the one or more electronic terminals of the integrated circuit.

33. The wearable apparatus of claim 32, wherein the integrated circuit is configured to operate in a stereo mode that merges the first audio signal and the second audio signal and the digital audio output is a stereo audio output.

34-44. (canceled)

45. The wearable apparatus of claim 30, the location monitoring assembly comprising:
a first plurality of electrical terminals configured to connect electrical signals of the distributed electrical circuit with first components of the location monitoring assembly;
a first integrated circuit comprising a triaxial accelerometer, a triaxial gyroscope and first electronic terminals for first electronic connections to and from the first integrated circuit;
first supportive electronic components configured to condition first electronic signals between the first integrated circuit and the first plurality of electrical terminals;
a flexible, stretchable, conformable first interposer comprising a first at least one substrate layer configured to receive and retain the first integrated circuit, the first supportive electronic components and the first plurality of electrical terminals, wherein the first integrated circuit is disposed in a first cavity of the first at least one substrate layer with the first electronic terminals facing away from the first cavity; and
a first plurality of conductive traces deposited on the first at least one substrate layer of the first interposer and arranged to interconnect the first electronic terminals of the first integrated circuit, the first supportive electronic components and the first plurality of electrical terminals for operation of the location monitoring assembly.

46. The wearable apparatus of claim 45, the location monitoring assembly further comprising:
a second plurality of electrical terminals configured to connect electrical signals of the distributed electrical circuit with second components of the location monitoring assembly;
a second integrated circuit comprising a triaxial geomagnetic sensor and second electronic terminals for second electronic connections to and from the second integrated circuit;
second supportive electronic components configured to condition second electronic signals between the second integrated circuit and the second plurality of electrical terminals;
a flexible, stretchable, conformable second interposer comprising a second at least one substrate layer configured to receive and retain the second integrated circuit, the second supportive electronic components and the second plurality of electrical terminals, wherein the second integrated circuit is disposed in a second cavity of the second at least one substrate layer with the second electronic terminals facing away from the second cavity;
a second plurality of conductive traces deposited on the second at least one substrate layer of the second interposer and arranged to interconnect the second electronic terminals of the second integrated circuit, the second supportive electronic components and the second plurality of electrical terminals for operation of the location monitoring assembly; and
at least one interface conductor configured to connect at least a portion of the second plurality of electrical terminals associated with the second interposer to at least a portion of the first plurality the electrical terminals associated with the first interposer to connect one or more geomagnetic output signal of the second integrated circuit to one or more auxiliary input signal of the first integrated circuit.

47-56. (canceled)

57. The wearable apparatus of claim 45, the first interposer further comprising:
an upper substrate layer configured to fuse with the first at least one substrate layer to form a flexible, stretchable, conformable outer casing enclosing the first integrated circuit, the first supportive electronic components and the first plurality of conductive traces within the first interposer with the first plurality of electrical terminals accessible for connection of the location monitoring assembly to the distributed electrical circuit,
wherein the location monitoring assembly further comprises a plurality of apertures through the first at least one substrate layer and the upper substrate layer, the plurality of apertures configured to improve breathability of the location monitoring assembly, configured to vent heat generated by the wearer of the garment and configured to wick moisture generated by the wearer of the garment, wherein the plurality of apertures are distributed throughout the location monitoring assembly.

58. The wearable apparatus of claim 30, the ambient light and ambient air temperature sensor assembly comprising:
a plurality of electrical terminals configured to connect electrical signals of the distributed electrical circuit with components of the ambient light and ambient air temperature sensor assembly;
an ambient light sensor configured to convert local light exposure to a light measurement signal;
an ambient air temperature sensor configured to convert local temperature exposure to a temperature measurement signal;
supportive electronic components configured to condition the light and temperature measurement signals between the ambient light and ambient air temperature sensors and the plurality of electrical terminals;
a flexible, stretchable, conformable interposer comprising at least one substrate layer configured to receive and retain the ambient light sensor, the ambient air temperature sensor and the supportive electronic components and the plurality of electrical terminals; and
a plurality of conductive traces deposited on the at least one substrate layer of the interposer and arranged to interconnect the ambient light sensor, the ambient air temperature sensor, the supportive electronic components and the plurality of electrical terminals for operation of the ambient light and ambient air temperature sensor assembly.

59-61. (canceled)

62. The wearable apparatus of claim 1, the at least one control assembly comprising:
a plurality of electrical terminals configured to connect electrical signals of the distributed electrical circuit with components of the at least one control assembly (210);
at least one switch mechanism configured to enable and control the distributed electrical circuit;
at least one indicator mechanism configured to indicate at least one status condition of the distributed electrical circuit;
supportive electronic components configured to condition control signals between the at least one switch mechanism, the at least one indicator mechanism and the plurality of electrical terminals;
a flexible, stretchable, conformable interposer comprising at least one substrate layer configured to receive and retain the at least one switch mechanism, the at least one indicator mechanism, the supportive electronic components and the plurality of electrical terminals; and
a plurality of conductive traces deposited on the at least one substrate layer of the interposer and arranged to interconnect the at least one switch mechanism, the at least one indicator mechanism, the supportive electronic components and the plurality of electrical terminals for operation of the at least one control assembly.

63-65. (canceled)

66. The wearable apparatus of claim 1, the distributed electrical circuit further comprising:
an open face magnetic connector interface in operative communication with the at least one microcontroller assembly, wherein the at least one microcontroller assembly and the open face magnetic connector interface are configured for data communication with an external device having a compatible open face magnetic connector.

67-69. (canceled)

70. A wearable apparatus, the wearable apparatus comprising:
a shirt configured to be worn by a wearer and comprising a visible outer face directed away from the wearer and an inconspicuous inner face directed toward the wearer, the shirt further comprising a pointed collar, a patch pocket, sleeve cuffs, a button placket, a pouch, a bottom hem, top seams, side seams and armhole seams; and
a distributed electrical circuit inconspicuously integrated within the shirt, the distributed electrical circuit comprising:
a battery assembly;
a microcontroller assembly;
at least one memory assembly;
an ambient sound sensor assembly;
a location monitoring assembly;
an ambient light and ambient air temperature assembly;
a control assembly; and
a plurality of conductors arranged to interconnect the battery assembly, the microcontroller assembly, the at least one memory assembly, the ambient sound sensor assembly, the location monitoring assembly, the ambient light and ambient air temperature assembly and the control assembly to form the distributed electrical circuit.

71-80. (canceled)

81. A method of manufacturing a wearable apparatus, the method comprising:
obtaining fabric pieces used to form a garment configured to be worn by a wearer and comprising a visible outer face directed away from the wearer and an inconspicuous inner face directed toward the wearer;
obtaining a battery assembly, at least one microcontroller assembly, at least one memory assembly, at least one sensor assembly, at least one control assembly used in a distributed electrical circuit; and
selecting locations in the garment to inconspicuously integrate the battery assembly, the at least one microcontroller assembly, the at least one memory assembly, the at least one sensor assembly and the at least one control assembly from candidate locations comprising (i) a collar, (ii) a lapel, (iii) a hood, (iv) at least one pocket, (v) at least one cuff, (vi) at least one placket, (vii) at least one pouch, (viii) at least one lining, (ix) at least one hem, (x) at least one seam and (xi) at least one double layered area.

82-83. (canceled)
